(19) United States
(12) Patent Application Publication
(10) Pub. No.: US 2024/0182698 A1
(43) Pub. Date: Jun. 6, 2024

(54) WATER-SOLUBLE POLYMER TO PREVENT NON-SPECIFIC ADSORPTION

(71) Applicant: N-LAB TECHNOLOGY CENTER PTE. LTD., Singapore (SG)

(72) Inventor: Honglei WANG, Singapore (SG)

(21) Appl. No.: 18/552,121

(22) PCT Filed: Mar. 23, 2022
(86) PCT No.: PCT/SG2022/050158

§ 371 Date: Sep. 22, 2023

(30) Foreign Application Priority Data
Mar. 26, 2021 (SG) 10202103164U

(51) Int. Cl. C08L 51/00; C08F 230/02; C08G 63/06

(52) U.S. Cl. CPC C08L 51/003; C08F 230/02; C08G 63/06

(57) ABSTRACT

The present invention relates to a water-soluble copolymer which prevents nonspecific adsorption of bio-substances, such as proteins and the like. It mainly applies to reagent, particles and the like which are used in clinical diagnoses, biochemical experiments, medical devices and the like.

### BRIEF DESCRIPTION OF THE BACKGROUND ART

Immunoassays are useful for discovering, detecting, and monitoring biological processes which express a distinctive proteomic “biomarker” signature by utilizing specific chemical interactions between antibodies and antigens. Immunoassays are becoming more important as both medical and research tools, and also in various scientific fields such as analytical chemistry, pharmacology, molecular cell biology, and clinical biochemistry. Immunoassays are now used in many laboratories worldwide, and many companies are marketing diagnostic or detection tools that employ immunoassays to determine the levels of specific analytes of interest, such as pollutants, hormones, disease markers, and pathogens.

However, immunoassays often suffer from low signal-to-noise (S/N) ratios at the early-stage of detection where the biomarker's concentration level is relatively low. A high sensitivity test is needed because a low S/N ratio gives rise to poor assay confidence, resulting in false positive or false negative results. This could arise from the high background noise caused by the nonspecific adsorption of both target and non-target molecules onto the assay platform. As a result, background noise increases and obstructs improvement of sensitivity. Among the different immunoassay techniques, chemiluminescence provides the highest detection limit as compared to colour change or fluorescence. However, the S/N of chemiluminescence immunoassays still needs to be further improved.

In the chemiluminescence immunoassay (CLIA), a potential cause of high noise level is the nonspecific adsorption of secondary antibodies which conjugate with the signal generators, such as antibodies labelled with acridinium esters or isoluminol derivates, alkaline phosphates and horseradish peroxidase. In the case of diagnosis in clinical samples, a specific substance such as an antigen is detected in the coexisting living body molecules. Substances such as serums and the like, which coexist in the living body molecules, tend to adsorb on the surface of particles. They can then render the surface to be more prone to non-specific adsorption of the secondary antibody labelled with signal generators. As a result, the noise increases and obstructs improvement of S/N ratios.

A general approach to improving S/N ratios of CLIA is to prevent nonspecific adsorption by using organism-derived substances such as albumin, casein, gelatin and the like as additive agents. However, even after using these additive agents, nonspecific adsorption remains. Furthermore, these biological additives often have huge batch to batch variation. For example, one batch of albumin may provide good results, but a subsequent batch may not work at all. There will be plenty of trial-and-error to pick out the workable batches. In addition, when using a living body-derived additive agent, organism pollution can be a problem. Furthermore, the prevention of nonspecific adsorption by these additive agents is hindered by washing with acid or alkali, surfactant aqueous solution and the like, and shows inferior durability. Efforts were made by using synthetic materials to passivate the surface. Examples of synthetic polymers prepared with the aim of preventing nonspecific adsorption include polyoxy ethylene (JP-A-5-103831, JP-A-2006 177914 and JP-A-2006-299045), and copolymers having a phosphorylcholine group (JP-A-2006-176720 and JP-A-2006-258585). However, their nonspecific adsorption preventive effect was insufficient. The possible reasons are (1) the structure of the copolymer is usually linear, so it may be difficult to achieve high coverage by using linear polymer; (2) the molecular weight of such block copolymer is usually low, so it may be difficult to achieve a thick coating layer on the target surface. Other polymers include aminodextrans and modified dextrans of various molecular weights (EP2230515A1). These polymers may be able to prevent non-specific adsorption against proteins and bio-substances having negative charge, but are not as effective against those showing having positive charge. Since biological samples are usually a mixture of antigens and antibodies, they may have biomolecules with various different charges in the same sample, and so these polymers may not be useful against many biological samples. There is therefore an unmet need for a polymers that are able to prevent non-specific adsorption to a complex mixture.

### SUMMARY OF THE INVENTION

The inventors have surprisingly found that by conjugating a polymer as defined herein onto the surface of a substrate, non-specific adsorption of biological molecules/material can be minimised. This may advantageously minimise background binding, improving the signal to noise ratio in an assay and leading to more accurate and reliable detection.

Aspects and embodiments of the invention are described in the following numbered clauses.
1. A water-soluble crosslinked copolymer formed by crosslinking a first polymer chain to a second polymer chain comprising a polycarboxylic acid, wherein
   the first chain before crosslinking comprises a constitutional unit (a) comprising a zwitterionic phosphorylcholine group, a constitutional unit (b) comprising an amine group and a constitutional unit (c) comprising a hydroxyl group; and
   the water-soluble crosslinked copolymer comprises one or more crosslinks formed between carboxylic acid groups in the second chain and amine groups in the first chain,
   optionally wherein said amine group in the first chain is a primary amine group.
2. The water-soluble crosslinked copolymer of Clause 1, which is a water-soluble crosslinked copolymer comprising:
   a first chain comprising a constitutional unit (A′) and/or (A″), a constitutional unit (B) and a constitutional unit (C), and
   a second chain comprising a constitutional unit (D),
   wherein the water-soluble crosslinked copolymer comprises one or more crosslinks between the first chain and the second chain:

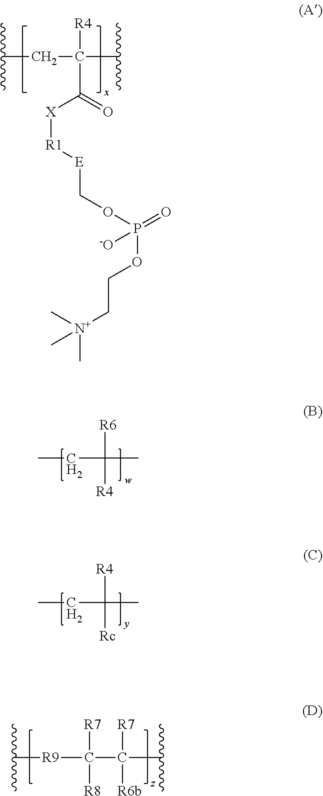

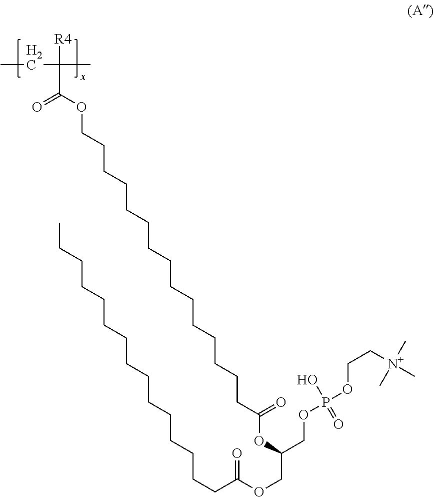

wherein:
X represents O or NH;
R1 represents a linear or branched alkylene group having from 1 to 5 carbon atoms;
E represents a covalent bond, —C(O)O—, —OC(O)—, —NHC(O)— or —C(O)NH—;
Rc represents a hydroxyl-containing group;
each R4 independently represents a methyl group or a hydrogen atom;
R6 represents a moiety comprising an amine group (e.g. a primary amine group) and R6b represents —COOH or —C(O)O—Y—COOH, where Y represents a C₁₋₅ alkylene group, provided that at least one R6 in the first chain is covalently connected to an R6b in the second chain via an amide bond formed between an amine group in said R6 and a carboxylic acid in said R6b;
each R7 is independently selected from the group consisting of a hydrogen atom, a methyl group, an ethyl group, a n-propyl group, an isopropyl group, a methoxyethyl group, a hydroxymethyl group, and a hydroxyethyl group;
R8 represents a carboxyl group or a hydrogen atom;
R9 represents a covalent bond, a linear or branched alkylene having from 1 to 10 carbon atoms, or a linear alkylene having from 1 to 5 carbon atoms having from 1 to 3 substituents selected from the group consisting of a methoxy group, a hydroxymethyl group, a hydroxyethyl group and a methoxyethyl group;
w, x, y, z are independently of each other, an integer of from 1 to 50.
3. The water-soluble crosslinked copolymer of Clause 1 or 2, wherein the weight average molecular weight of the water-soluble crosslinked copolymer is from 2,000 to 1,000,000 Daltons, preferably 5,000 to 500,000 Daltons, more preferably from 10,000 to 250,000 Daltons.
4. The water-soluble crosslinked copolymer of Clause 2 or 3, wherein said first chain is a random copolymer comprising constitutional unit (A′) and/or (A″), constitutional unit (B) and constitutional unit (C).
5. The water-soluble crosslinked copolymer of any one of Clauses 2 to 4, wherein
   the first chain comprises a constitutional unit (A′) where X is O, R1 is methylene and E is a covalent bond; or
   the first chain comprises a constitutional unit (A″).
6. The water-soluble crosslinked copolymer of any one of Clauses 2 to 5, wherein constitutional unit (B) represents a constitutional unit formed from the polymerisation of one of the group consisting of allylamine hydrochloride, 4-vinylaniline, 2-aminoethyl methacrylate hydrochloride, 2-aminoethyl acrylate, amino acrylate, N-(2-aminoethyl) methacrylamide hydrochloride, N-(3-aminopropyl)methacrylamide hydrochloride, and 2-aminoethyl methacrylate phenothiazine (e.g. N-(2-aminoethyl) methacrylamide hydrochloride).
7. The water-soluble crosslinked copolymer of any one of Clauses 2 to 5, wherein constitutional unit (B) has the formula

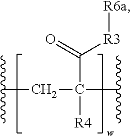

wherein
R3 represents O or NH, R4 is as defined in Clause 2 and R6a represents —Y—CH₂—NH₂ or —Z—NH₂, where Y represents a C₁₋₅ alkylene group and Z represents a C₆₋₁₂ aryl group.
8. The water-soluble crosslinked copolymer of any one of Clauses 2 to 7, wherein constitutional unit (C) has the formula

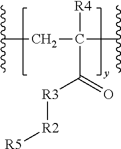

wherein
R2 represents a linear or branched alkylene group having from 1 to 18 carbon atoms, a polyoxyalkylene group with a unit number of from 1 to 20, or an arylene group having from 6 to 18 carbon atoms,
R3 represents O or NH;
R4 is as defined in Clause 2;
R5 represents CₙH₂ₙ₋ₘ₊₁(OH)ₘ, where n represents an integer of from 1 to 5, and m is 1, 2 or 3.
9. The water-soluble crosslinked copolymer of Clause 8, wherein m is 1.
10. The water-soluble crosslinked copolymer of Clause 8 or 9, wherein R2 represents an ethylene glycol or a propylene glycol having from 1 to 20 repeating units.
11. The water-soluble crosslinked copolymer of any one of Clauses 2 to 7, wherein constitutional unit (C) is a constitutional unit formed from the polymerisation of one of the group consisting of 2-hydroxyethyl methacrylate, 2-hydroxyethyl acrylate, hydroxypolyethoxy (10) Allyl Ether, N-(2-hydroxypropyl)methacrylamide, glycerol monomethacrylate, 3-phenoxy 2 hydroxy propyl methacrylate, hydroxypropyl methacrylate, 4-hydroxybutyl acrylate, 2-hydroxypropyl acrylate, N-hydroxyethyl acrylamide, poly(ethylene glycol) methacrylate, poly(propylene glycol) methacrylate, and N-[tris(hydroxymethyl)methyl]acrylamide.
12. The water-soluble crosslinked copolymer of any one of the preceding Clauses, wherein the weight average molecular weight of the first chain is from 500 to 100,000 Daltons, preferably from 2,000 Daltons to 50,000 Daltons.
13. The water-soluble crosslinked copolymer of any one of Clauses 2 to 12, wherein constitutional unit (D) is a constitutional unit formed from the polymerisation of one of the group consisting of poly(acrylic acid), polymethacrylic acid, polystyrene-block-poly(acrylic acid), polymaleic acid, poly(acrylic acid-co-maleic acid), poly(D,L-lactide-block-acrylic acid), poly(acrylamide-co-acrylic acid), poly(N-isopropylacrylamide-co-acrylic acid), and poly(ethylene-co-acrylic acid).
14. The water-soluble crosslinked copolymer of Clause 13, wherein constitutional unit (D) is a constitutional unit formed from the polymerisation of one of the group consisting of acrylic acid, methacrylic acid and 2-carboxyethyl acrylate.
15. The water-soluble crosslinked copolymer of any one of the preceding Clauses, wherein the weight average molecular weight of the second chain is from 2,000 to 700,000 Daltons, preferably 5,000 to 350,000 Daltons, more preferably from 10,000 to 250,000 Daltons.
16. The water-soluble crosslinked copolymer of any one of the preceding Clauses, wherein from 5% to 75% of carboxylic acid groups in the second chain are crosslinked to amine groups in the first chain, preferably from 10% to 50%.
17. A method for the preparation of the water-soluble crosslinked copolymer of any one of the preceding Clauses, comprising the steps:
   (a) mixing a monomer corresponding to constitutional unit (1), a monomer corresponding to constitutional unit (2), and a monomer corresponding to constitutional unit (3) in a solvent (e.g. water);
   (b1) polymerising the monomer mixture, optionally by adding an initiator and heating to a temperature of from 55 to 90° C. for 5 to 24 hours; and
   (c1) conjugating the polymer obtained in step (b1) to a polycarboxylic acid to form the water-soluble crosslinked copolymer, optionally in the presence of a buffer having a pH from 4.5 to 8.5.
18. The method of Clause 17, further comprising a step (d):
   (d) conjugating the water-soluble crosslinked copolymer obtained in step (c1) to a substrate.
19. The method of Clause 17, further comprising a step (b2) or (co):
   (b2) conjugating the polymer obtained in step (b1) to a substrate before step (c1); or
   (c0) conjugating the polycarboxylic acid in step (c1) to a substrate before conjugating the polymer obtained in step (b1) to the polycarboxylic acid.
20. The method of Clause 18 or 19, wherein the substrate is selected from particles, hollow filters, plastic tubes, glass fibers, glass slides, microplates and microfluidic devices, (e.g. wherein the substrate is selected from particles, hollow filters, microplates and microfluidic devices).
21. The method of any one of Clauses 18 to 20, wherein the material of the substrate is selected from polymeric, organic or composite materials, such as polyurethanes, polyacrylonitriles, polymethacrylate, carbon fibers, cellulosic materials, polyacrylamide, polyacrylate, polyolefins, poly(4-methylbutene, polystyrene, poly(ethylene terephthalate), polysiloxanes, nylon, poly(vinyl butyrate), ferromagnetic materials, silica, or mixtures or composites of any of the above.
22. The method of any one of Clauses 18 to 21, wherein the substrate is functionalised with one or more of the group consisting of a primary amine, an epoxide group, a tosyl group and an aldehyde group.
23. The method of Clause 22, wherein the substrate is functionalised with a primary amine.
24. A substrate comprising the water-soluble crosslinked copolymer of any one of Clauses 1 to 16.

### BRIEF DESCRIPTION OF THE DRAWINGS

FIG. 1 depicts protein adsorption on different type of beads

### DETAILED DESCRIPTION OF THE INVENTION

It has been surprisingly found that the problems above can be solved in whole or in part by the use of a water-soluble crosslinked copolymer as defined herein.

Biological samples are usually a complex mixture of lipids, antigens and antibodies. Since they may have totally opposite charge in the same environment, it is important that a surface inhibits non-specific adsorption of a complex mixture. For example, the isoelectric point of Beta-HCG is 6.2-6.6 while the isoelectric point of Thyrotropin receptor (TSHR) is 8-10. This means under neutral pH, Beta-HCG is positively charged and Thyrotropin receptor (TSHR) is negatively charged. An ideal surface preventing non-specific adsorption of bio-substances should not adsorb any of them under the same buffer pH. It has surprisingly been found that by conjugating the polymer of the invention on the surface of a substrate, the non-specific adsorption can be minimised. It is believed that chemiluminescence immunoassays utilising this coating will improve the signal to noise ratio and minimise background binding, leading to accurate and reliable detection. As will be appreciated by a person skilled in the art, the polymer of the invention may be useful in coatings for other materials, where non-specific adsorption (e.g. of biomolecules such as proteins) is desired.

In embodiments herein, the word “comprising” may be interpreted as requiring the features mentioned, but not limiting the presence of other features. Alternatively, the word “comprising” may also relate to the situation where only the components/features listed are intended to be present (e.g., the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

In embodiments herein, various features may be described in the singular or the plural. It is herein explicitly contemplated that references to the singular are to be understood as including the plural, and references to the plural are to be understood as including the singular, unless such an interpretation would be technically illogical.

The water-soluble crosslinked copolymer of the invention may be referred to herein as the polymer (of the invention), the copolymer (of the invention), the water-soluble copolymer (of the invention), the water-soluble polymer (of the invention), or the like.

Some of the advantages of the water-soluble crosslinked copolymer and the relevant methods to realise the surface preventing non-specific adsorption of bio-substances on substrates include the following.
The water-soluble crosslinked copolymers only utilise the most common bioconjugation reaction mechanism to conjugate on the surface of the substrate. Such conditions are mild and will not impact the configurations of ligands, such as antibodies, streptavidin etc.
The water-soluble crosslinked copolymer is a good replacement of the organism-derived substances, such as albumin, casein, gelatin and the like as additive agents. By using water-soluble crosslinked copolymer as an additive, the risk of organism pollution can be mitigated.
Different from conventional methods, in which the additives such as albumin, casein, gelatin and the like are only attached on the substrate surface through physical adsorption, the water-soluble crosslinked copolymer is covalently bonded on the surface. It shows durability during repeatedly washing with surfactant buffer solution.
The water-soluble crosslinked copolymers exhibit excellent performance under a wide pH range and it also shows resistance to proteins with different isoelectric points.
The water-soluble crosslinked copolymers help to improve the signal to noise ratio in chemiluminescence immunoassays and minimise background binding, leading to accurate and reliable detection and higher purification yield

The water-soluble copolymers are useful for preventing non-specific adsorption of a substance including lipids, proteins, saccharides or nucleic acids, and cells. According to the present invention, the water-soluble copolymer may be formed by crosslinking a first polymer chain to a second polymer chain comprising a polycarboxylic acid, wherein
the first chain before crosslinking comprises a constitutional unit (a) comprising a zwitterionic phosphorylcholine group, a constitutional unit (b) comprising an amine group (e.g. a primary amine group) and a constitutional unit (c) comprising a hydroxyl group; and
the water-soluble crosslinked copolymer comprises one or more crosslinks formed between carboxylic acid groups in the second chain and (primary) amine groups in the first chain.

The water-soluble crosslinked polymer of the invention may be a water-soluble crosslinked copolymer comprising:
a first chain comprising a constitutional unit (A′) and/or (A″), a constitutional unit (B) and a constitutional unit (C), and
a second chain comprising a constitutional unit (D),
wherein the water-soluble crosslinked copolymer comprises one or more crosslinks between the first chain and the second chain:

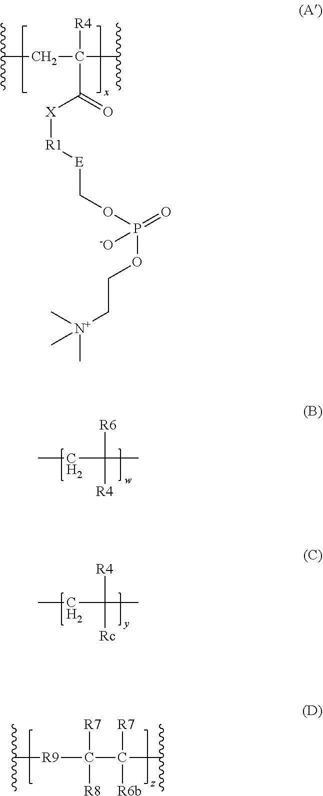

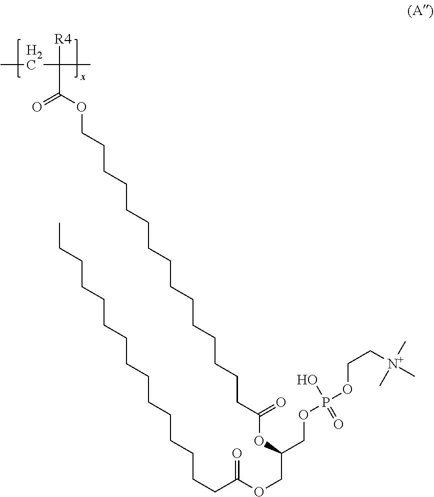

wherein:
X represents O or NH;
R1 represents a linear or branched alkylene group having from 1 to 5 carbon atoms;
E represents a covalent bond, —C(O)O—, —-OC(O)—, —NHC(O)— or —C(O)NH—;
Rc represents a hydroxyl-containing group;
each R4 independently represents a methyl group or a hydrogen atom;
R6 represents a moiety comprising an amine group (e.g. a primary amine group) and R6b represents —COOH or —C(O)O—Y—COOH, where Y represents a C₁₋₅ alkylene group, provided that at least one R6 in the first chain is covalently connected to an R6b in the second chain via an amide bond formed between a (primary) amine group in said R6 and a carboxylic acid in said R6b;
each R7 is independently selected from the group consisting of a hydrogen atom, a methyl group, an ethyl group, a n-propyl group, an isopropyl group, a methoxyethyl group, a hydroxymethyl group, and a hydroxyethyl group;
R8 represents a carboxyl group or a hydrogen atom;
R9 represents a covalent bond, a linear or branched alkylene having from 1 to 10 carbon atoms, or a linear alkylene having from 1 to 5 carbon atoms having from 1 to 3 substituents selected from the group consisting of a methoxy group, a hydroxymethyl group, a hydroxyethyl group and a methoxyethyl group;
w, x, y, z are independently of each other, an integer of from 1 to 50.

The weight average molecular weight of the water-soluble crosslinked copolymer of the invention is from 2,000 to 1,000,000 Daltons, preferably 5,000 to 500,000 Daltons, more preferably from 10,000 to 250,000 Daltons. When the weight average molecular weight of the water-soluble copolymer is lower than 2,000 Daltons, the effect of preventing non-specific adsorption of bio-substances becomes negligible. On the other hand, when the weight average molecular weight of the water-soluble copolymer is higher than 1,000,000 Daltons, it will become infeasible to prepare a solution due to the increased viscosity of the polymer solution.

The first chain of the water-soluble crosslinked polymer may be a random copolymer comprising constitutional unit (A′) and/or (A″), constitutional unit (B) and constitutional unit (C). For example, in some embodiments the first chain of the water-soluble crosslinked polymer may be a random copolymer comprising constitutional unit (A′), constitutional unit (B) and constitutional unit (C). In some embodiments, the first chain of the water-soluble crosslinked polymer may be a random copolymer comprising constitutional unit (A″), constitutional unit (B) and constitutional unit (C).

The proportion of carboxylic acid groups in the second chain that are crosslinked to amine groups in the first chain may be from 5% to 75%, for example from 10% to 50%. In some embodiments, the first chain comprises a constitutional unit (A′) where X is O, R1 is methylene and E is a covalent bond. In some embodiments the first chain comprises a constitutional unit (A″).

In some embodiments, constitutional unit (B) represents a constitutional unit formed from the polymerisation of one of the group consisting of allylamine hydrochloride, 4-vinylaniline, 2-aminoethyl methacrylate hydrochloride, 2-aminoethyl acrylate, amino acrylate, N-(2-aminoethyl) methacrylamide hydrochloride, N-(3-aminopropyl)methacrylamide hydrochloride, and 2-aminoethyl methacrylate phenothiazine.

In some embodiments, constitutional unit (B) represents a constitutional unit formed from the polymerisation of one of the group consisting of allylamine hydrochloride, 2-aminoethyl methacrylate hydrochloride, 2-aminoethyl acrylate, amino acrylate, N-(2-aminoethyl) methacrylamide hydrochloride, N-(3-aminopropyl)methacrylamide hydrochloride, and 2-aminoethyl methacrylate phenothiazine (e.g. N-(2-aminoethyl) methacrylamide hydrochloride).

In some embodiments, constitutional unit (B) represents a constitutional unit formed from the polymerisation of one of the group consisting of allylamine hydrochloride, 2-aminoethyl methacrylate hydrochloride, 2-aminoethyl acrylate, N-(2-aminoethyl) methacrylamide hydrochloride, and N-(3-aminopropyl)methacrylamide hydrochloride.

In some embodiments, constitutional unit (B) represents a constitutional unit formed from the polymerisation of allylamine hydrochloride.

In some embodiments, constitutional unit (B) is a constitutional unit as defined above that comprises a primary amine group.

In some embodiments, constitutional unit (B) has the formula

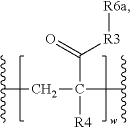

wherein
R3 represents O or NH, R4 is as defined above, and R6a represents —Y—CH₂—NH₂ or —Z—NH₂, where Y represents a C₁₋₅ alkylene group (e.g. a C₁₋₃ alkylene group) and Z represents a C₆₋₁₂ aryl group.

In embodiments, R6a represents —Y—CH₂—NH₂, such that R6a comprises a primary amine. In some embodiments Y represents a C₁₋₃ alkylene group.

In some embodiments constitutional unit (C) has the formula

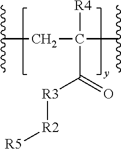

wherein
R2 represents a linear or branched alkylene group having from 1 to 18 carbon atoms, a polyoxyalkylene group with a unit number of from 1 to 20, or an arylene group having from 6 to 18 carbon atoms,
R3 represents O or NH;
R4 is as defined above;
R5 represents CₙH₂ₙ₋ₘ₊₁(OH)ₘ, where n represents an integer of from 1 to 5, and m is 1, 2 or 3.

In some embodiments R2 represents an ethylene glycol or a propylene glycol having from 1 to 20 repeating units. In some embodiments R2 represents a linear or branched alkylene group having from 1 to 5 carbon atoms.

In some embodiments, R2 represents a polyoxyalkylene group (e.g. ethylene glycol or propylene glycol) with a unit number of from 1 to 20, such as a unit number of from 3 to 10.

In some embodiments m is 1. In some embodiments n is 1, 2 or 3, such as 1 or 2.

In some embodiments constitutional unit (C) is a constitutional unit formed from the polymerisation of one of the group consisting of 2-hydroxyethyl methacrylate, 2-hydroxyethyl acrylate, hydroxypolyethoxy (10) Allyl Ether, N-(2-hydroxypropyl)methacrylamide, glycerol monomethacrylate, 3-phenoxy 2 hydroxy propyl methacrylate, hydroxypropyl methacrylate, 4-hydroxybutyl acrylate, 2-hydroxypropyl acrylate, N-hydroxyethyl acrylamide, poly(ethylene glycol) methacrylate, poly(propylene glycol) methacrylate, and N-[tris(hydroxymethyl)methyl]acrylamide (e.g. 2-hydroxyethyl methacrylate).

In some embodiments, constitutional unit (C) is a constitutional unit formed from the polymerisation of one of the group consisting of hydroxypolyethoxy (10) Allyl Ether and poly(ethylene glycol) methacrylate, poly(propylene glycol) methacrylate.

In some embodiments the weight average molecular weight of the first chain is from 500 to 100,000 Daltons, preferably from 2,000 Daltons to 50,000 Daltons.

In some embodiments constitutional unit (D) is a constitutional unit formed from the polymerisation of one of the group consisting of poly(acrylic acid), polymethacrylic acid, polystyrene-block-poly(acrylic acid), polymaleic acid, poly(acrylic acid-co-maleic acid), poly(D,L-lactide-block-acrylic acid), poly(acrylamide-co-acrylic acid), poly(N-isopropylacrylamide-co-acrylic acid), and poly(ethylene-co-acrylic acid), such as a constitutional unit formed from the polymerisation of one of the group consisting of acrylic acid, methacrylic acid and 2-carboxyethyl acrylate.

In some embodiments the weight average molecular weight of the second chain is from 2,000 to 700,000 Daltons, preferably 5,000 to 350,000 Daltons, more preferably from 10,000 to 250,000 Daltons.

The invention also provides a method for the preparation of the water-soluble crosslinked copolymer of the invention, comprising the steps:
(a) mixing a monomer corresponding to constitutional unit (1), a monomer corresponding to constitutional unit (2), and a monomer corresponding to constitutional unit (3) in a solvent (e.g. water);
(b1) polymerising the monomer mixture, optionally by adding an initiator and heating to a temperature of from 55 to 90° C. for 5 to 24 hours; and
(c1) conjugating the polymer obtained in step (b1) to a polycarboxylic acid to form the water-soluble crosslinked copolymer, optionally in the presence of a buffer having a pH from 4.5 to 8.5.

The method may further comprise a step (d):
(d) conjugating the water-soluble crosslinked copolymer obtained in step (c1) to a substrate.

Alternatively, immobilisation on a substrate may be performed before the water-soluble crosslinked copolymer is fully synthesised. For example, the method may further comprise a step (b2) or (c0):
(b2) conjugating the polymer obtained in step (b1) to a substrate before step (c1); or
(c0) conjugating the polycarboxylic acid in step (c1) to a substrate before conjugating the polymer obtained in step (b1) to the polycarboxylic acid.

More specific methods for preparing the copolymers of the invention are provided below.
(a) mix the monomers in a solvent, for example water;
(b) start polymerisation by adding an initiator under desired temperature typically between 55 and 90° C.;
(c) continue reaction under heating for 5-24 hours;
(d) purify the reactant mixture by re-precipitation, extraction, dialysis and the like;
(e) conjugate the polymer obtained in step (d) (terpolymer) to a polyacid backbone in buffer, eg. buffer with pH 4.5-8.5 through carbodiimide coupling mechanism and the like.
(f) remove the unreacted terpolymer through dialysis or column and the like.

Optionally, the terpolymer can be used to conjugate to the polyacid backbone which has been coated on a substrate, then step (f) is not required.

The substrate may be selected from particles, hollow filters, plastic tubes, glass fibers, glass slides, microplates and microfluidic devices, (e.g. wherein the substrate is selected from particles, hollow filters, microplates and microfluidic devices, such as particles, hollow filters, and microfluidic devices).

The material of the substrate may be selected from at least one of the following polymeric, organic or composite materials, such as polyurethanes, polyacrylonitriles, polymethacrylate, carbon fibers, cellulosic materials, polyacrylamide, polyacrylate, polyolefins, poly(4-methylbutene, polystyrene, poly(ethylene terephthalate), polysiloxanes, nylon, poly(vinyl butyrate), ferromagnetic materials, silica, or mixtures or composites of any of the above.

The abovementioned substrate may be further functionalised with anchoring groups, which can further react with the water-soluble copolymer in the present embodiment, selected from primary amine, epoxide group, tosyl group and aldehyde group.

The water-soluble copolymer in the present invention may be conjugated on a substrate by (1) dissolving water-soluble branched copolymer in the buffer with pH 4.5-8.5, (2) activating the water-soluble branched copolymer, (3) mixing the water-soluble branched copolymer with the substrate after activation; (4) wash off the unbonded water-soluble branched copolymer.

Optionally, the water-soluble copolymer in the present embodiment may be conjugated on a substrate by (1) dissolving the terpolymer in the buffer with pH 4.5-8.5; (2) activating the substrate surface and (3) mixing the substrate with the terpolymer solution; (4) wash off the unbonded water-soluble branched copolymer.

Optionally, the water-soluble copolymer in the present embodiment may be conjugated on a substrate by (1) dissolving water-soluble branched copolymer in the buffer with pH 4.5-8.5, (2) mixing with the substrate with functional groups selected from epoxide group, tosyl group and aldehyde group.

### EXAMPLES

### Materials and Equipment

The materials were purchased from the sources as provided below.
Styrene: Tokyo Chemical Industry (TCI), stabilized with TBC (4-tert-butylcatechol), >99.0%(GC).
Azobisisobutyronitrile (AIBN): Sigma-Aldrich (12 wt % in acetone).
Sodium persulfate (Na₂S₂O₈, SPS): Alfa Aesar, crystalline, 98%.
Polyvinylpyrrolidone (PVP, K30, MW=40,000): TCI, total nitrogen 12.0% to 12.8% (calcd.on anhydrous substance); water max. 7.0%, K value 26.0 to 34.0.
Divinylbenzene (DVB, m- and p-mixture): TCI, 50.0%(GC) (contains ethylvinylbenzene, diethylbenzene) (stabilized with 4-tert-butylcatechol).
2-hydroxyethyl methacrylate: Sigma-Aldrich, ≥99.0%
2-carboxyethyl acrylate oligomers: Sigma-Aldrich, 2000 ppm MEHQ as inhibitor.
N-hydroxysuccinimide (NHS), >98%, TCI
Ethanol: 99%, Aik Moh
Acrylamide Monomer (ca. 50% in Water), TCI
1-(3-Dimethylaminopropyl)-3-ethylcarbodiimide hydrochloride (EDC), >98%, TCI
Deionized (DI) water: obtained from ELGA Ultrapure Water Treatment Systems (PURELAB Option).
10×Phospahte Buffered Saline, Sigma-Aldrich
MES Hydrate, >99.5%, Sigma-Aldrich
Amine-PEG-Carboxylic acid hydrochloride, Polysciences, Inc
2-(methacryloyloxy)ethyl dimethyl-(3-sulfopropyl)ammonium hydroxide, Sigma-Aldrich
2-Methacryloyloxyethyl-phosphorylcholine, Sigma-Aldrich
Bovine serum albumin, Sigma-Aldrich
Lysozyme, Sigma-Aldrich
Mechanical stirrer: Wiggens, WB2000-M overhead stirrer.
Classic Tube Roller: SCILOGEX MX-T6-S

Mechanical stirring (200 rpm) was used for all the polymerization processes. Prior to use, DI water and ethanol were bubbled with nitrogen for 20 min to remove oxygen. All the chemicals were used as received without purification. All the polymerizations and reactions were carried out under the protection of nitrogen using standard Schlenk line techniques.

### Example 1

### Synthesis of Terpolymer

To a 100 mL three-necked round bottom glass reactor equipped with a mechanical stirrer, 50 g of water, 0.5 g of 2-Methacryloyloxyethyl-phosphorylcholine as the monomer (1), 0.01 g of N-(2-aminoethyl) methacrylamide hydrochloride as the monomer (2), 1 g of 2-hydroxyethyl methacrylate as the monomer (3) were added and nitrogen was introduced from one side-neck to remove oxygen. After 10 minutes of nitrogen flow, the glass reactor was heated up to 75° C. 5 mg of sodium persulfate as initiator was added after the temperature of the glass reactor was stable at 75° C. The mixture was mixed for 24 hours to allow polymerization complete. The obtained solution was purified by dialysis.

### Example 2

### Synthesis of Polyacid Backbone

To a 100 mL three-necked round bottom glass reactor equipped with a mechanical stirrer, 50 g of water and 1 g of 2-carboxyethyl acrylate as the monomer (4) were added into the glass reactor and nitrogen was introduced from one side-neck to remove oxygen. After 10 minutes of nitrogen flow, the glass reactor was heated up to 75° C. 5 mg of sodium persulfate as initiator was added after the temperature of glass reactor was stable at 75° C. The mixture was mixed for 24 h to allow polymerization complete. The obtained polycarboxylic acid solution was purified by dialysis with MES buffer.

### Example 3

### Water-Soluble Copolymer Preparation

EDC and NHS were dissolved separately in 25 mM MES buffer to achieve concentration 50 mg/mL. 20 μl of EDC solution was added per 1 mg of polycarboxylic acid backbone and followed by 20 μl of NHS solution. The solution was mixed for 30 min before adding into terpolymer solution with the ratio of 25 mg of terpolymer per 1 mg of polycarboxylic acid. The mixture was mixed for another 2 h. The obtained water-soluble copolymer solution was purified by dialysis.

### Example 4

### Water-Soluble Copolymer Conjugation to a Microsphere Surface With Primary Amine Moieties on the Surface

To a 250 mL three-necked round bottom glass reactor equipped with a mechanical stirrer, AIBN solution (2 g, 12 wt % in acetone) was added and nitrogen was introduced from one side-neck to remove acetone solvent. After 10 minutes of nitrogen flow, dried AIBN powder was observed at the bottom of the reactor. Then PVP (0.2 g), ethanol (80 mL), and DI water (20 mL) were added. The mixture was stirred at room temperature for 5 minutes to obtain a clear solution, which was then heated to 60° C.with an oil bath, followed by addition of styrene (7.5 mL). A white colloidal solution was generated after 4 hours, indicating polymerization of styrene. A solution of DVB (3 mL DVB in 7 mL ethanol) was then slowly added with a constant pressure dropping funnel over 30 minutes. After addition of DVB solution was completed, the reaction (cross-linking polymerization) was continued for 3 hours. Then a monomer solution of 2-hydroxyethyl methacrylate (0.75 g in 5 mL ethanol) and acrylamide monomers (0.75 g in 5 mL ethanol, neutralized with ammonia solution, 25% W/W) was added with a syringe. The reaction (polymerization) was continued for 6 hours to give a milk-like colloidal solution. The obtained beads were named as “A-1”. The beads were washed with ethanol by using centrifuge with 7000G force for 9 min. The supernatants were discarded and microspheres were resuspended in 25 mM MES buffer.

EDC and NHS were dissolved separately in 25 mM MES buffer to concentration 50 mg/mL. 20 μl of EDC solution was added per 1 mg of water-soluble copolymer and followed by 20 μl of NHS solution. The suspension was mixed with 3 mg of beads A-1 with to achieve concentration of 10 mg/ml. The mixture was mixed for another 2 h. The resultant beads A-2 were washed with Tris buffer by using centrifuge with 9000 rpm for 11 min. The supernatants were discarded and microspheres were resuspended in 1×PBS buffer.

### Example 5

### Terpolymer Conjugation to a Microsphere Surface With Polyacid Backbone on the Surface Water-Soluble Copolymer Conjugation to a Microsphere Surface With Polycarboxylic Acid on the Surface

To a 250 mL three-necked round bottom glass reactor equipped with a mechanical stirrer, AIBN solution (2 g, 12 wt % in acetone) was added and nitrogen was introduced from one side-neck to remove acetone solvent. After 10 minutes of nitrogen flow, dried AIBN powder was observed at the bottom of the reactor. Then PVP (0.2 g), ethanol (80 mL), and DI water (20 mL) were added. The mixture was stirred at room temperature for 5 minutes to obtain a clear solution, which was then heated to 60° C. with an oil bath, followed by addition of styrene (7.5 mL). A white colloidal solution was generated after 4 hours, indicating polymerization of styrene. A solution of DVB (3 mL DVB in 7 mL ethanol) was then slowly added with a constant pressure dropping funnel over 30 minutes. After addition of DVB solution was completed, the reaction (cross-linking polymerization) was continued for 3 hours. Then a monomer solution of 2-hydroxyethyl methacrylate (0.75 g in 5 mL ethanol) and carboxyethyl acrylate oligomers (0.75 g in 5 mL ethanol, neutralized with ammonia solution, 25% W/W) was added with a syringe. The reaction (polymerization) was continued for 6 hours to give a milk-like colloidal solution. The obtained beads were named as “B-1”. The beads were washed with ethanol by using centrifuge with 7000G force for 9 min. The supernatants were discarded and microspheres were resuspended in 25 mM MES buffer.

EDC and NHS were dissolved separately in 25 mM MES buffer to concentration 50 mg/mL. 20 μl of EDC solution was added per 3 mg of beads B-1 and followed by 20 μl of NHS solution. The mixture was mixed for 30 min. The resulted activated beads were centrifuged with 7000G force for 9 min to remove supernatant. The terpolymer solution (20 mg/ml) was then added to the active beads and mixed for 2 h. The resultant beads B-2 were washed with Tris buffer by using centrifuge with 9000 rpm for 11 min. The supernatants were discarded and microspheres were resuspended in 1×PBS buffer.

### Example 6

### Comparative Example 6-1

The water-soluble copolymer (II) was synthesized following the exact steps in example 1, 2, 3. Except monomer (1) was changed to 2-(methacryloyloxy)ethyl dimethyl-(3-sulfopropyl)ammonium hydroxide. The microsphere sample C-1 was prepared following steps in example 4.

### Comparative Example 6-2

The water-soluble copolymer (III) was synthesized following the exact steps. Except monomer (3) was not added during terpolymer synthesis in step 1. The microsphere sample C-2 was prepared following steps in Example 4.

### Comparative Example 6-3

The microsphere sample B-1 was conjugated with Amine-PEG-Carboxylic acid hydrochloride (Mn 2000 Dalton) by using similar protocol in Example 5. EDC and NHS were dissolved separately in 25 mM MES buffer to concentration 50 mg/mL. 20 μl of EDC solution was added per 3 mg of beads B-1 and followed by 20 μl of NHS solution. The mixture was mixed for 30 min. The resulted activated beads were centrifuged with 9000 rpm for 11 min to remove supernatant. The terpolymer solution (20 mg/ml) was then added to the active beads and mixed for 2 h. The resultant beads C-3 were washed with Tris buffer by using centrifuge with 9000G force for 11 min. The supernatants were discarded and microspheres were resuspended in 1×PBS buffer.

### Example 7

### Nonspecific Adsorption Test

BSA and lysozyme have different isoelectric points. BSA (isoelectric point 5.5) and lysozyme (isoelectric point 11) are commonly used model proteins for studies. In this evaluation, both were used to evaluate nonspecific adsorption effect of different type of beads surface.

BSA and lysozyme were dissolved in 1×PBS buffer solution to prepare stock solution with concentration of 0.2 mg/ml, respectively. A total dry mass of 0.1 mg of protein was added per 1 mg dry mass of beads sample (10 mg/ml, 0.1 ml). A series of beads samples prepared in Examples 4, 5 and 6 were studied.

The beads-protein suspensions were mixed at 25° C. for 2 h to achieve adsorption equilibrium. The samples were centrifuged with 9000 rpm for 11 min to precipitate the particles. The protein content in supernatants were determined by using UV-Vis spectroscopy under 280 nm. The amount of adsorbed protein on the beads surface was calculated by equation (1).

$$\\ \begin{matrix}{y}_{ad} = \frac{{P}_{tot} - {P}_{s}}{{P}_{tot}} \times 100 \% & ( 1 )\end{matrix}$$

y_{ad} represents the percentage of the protein adsorbed on the beads surface, in %;
Pₜₒₜ represent the total amount of protein dosed, in mg;
Pₛ represents the amount of protein in the supernatant, in mg.

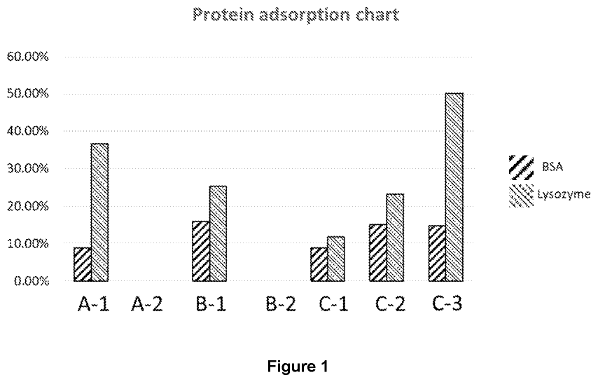

As shown in FIG. 1, when the water-soluble copolymer in the present embodiment is coated on the beads surface (See A-2 and B-2), there is no adsorption of either BSA or lysozyme. When only polyacid backbone is coated on the surface of beads (see B1), the adsorption of lysozyme is more significant than BSA. This is believed to be because BSA is negatively charged while lysozyme is positively charged in 1×PBS buffer, and so is expected to be more prone to adsorption on a negatively charged surface. The combination of 2-Methacryloyloxyethyl-phosphorylcholine and 2-hydroxyethyl methacrylate, was able to prevent any adsorption of BSA and lysozyme. This performance was superior to 2-(methacryloyloxy)ethyl dimethyl-(3-sulfopropyl)ammonium hydroxide or 2-Methacryloyloxyethyl-phosphorylcholine alone. In addition, linear PEG which is a commonly used antifouling brush to prevent nonspecific adsorption shows the highest non-specific adsorption for both proteins (i.e. worst performance).

It is therefore clear that the invention provides an improved coating for preventing non-specific adsorption of biomolecules onto surfaces. The invention is able to prevent non-specific adsorption on both positively-charged (amine, Example 4) and negatively-charged (carboxylic acid, Example 5) surfaces.

1. A water-soluble crosslinked copolymer formed by crosslinking a first polymer chain to a second polymer chain comprising a polycarboxylic acid, wherein
the first chain before crosslinking comprises a constitutional unit (a) comprising a zwitterionic phosphorylcholine group, a constitutional unit (b) comprising an amine group and a constitutional unit (c) comprising a hydroxyl group; and
the water-soluble crosslinked copolymer comprises one or more crosslinks formed between carboxylic acid groups in the second chain and amine groups in the first chain,
optionally wherein said amine group in the first chain is a primary amine group.

2. The water-soluble crosslinked copolymer of claim 1, which is a water-soluble crosslinked copolymer comprising:
a first chain comprising a constitutional unit (A′) and/or (A″), a constitutional unit (B) and a constitutional unit (C), and
a second chain comprising a constitutional unit (D),
wherein the water-soluble crosslinked copolymer comprises one or more crosslinks between the first chain and the second chain: 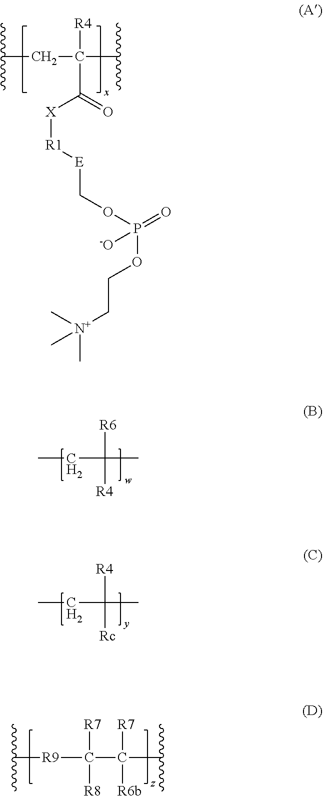 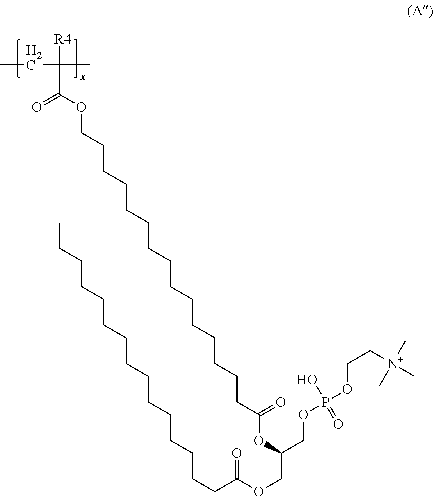
wherein:
X represents O or NH;
RI represents a linear or branched alkylene group having from 1 to 5 carbon atoms;
E represents a covalent bond, —C(O)O—, —OC(O)—, —NHC(O)— or —C(O)NH—;
Rc represents a hydroxyl-containing group;
each R4 independently represents a methyl group or a hydrogen atom;
R6 represents a moiety comprising an amine group and R6b represents —COOH or —C(O)O—Y—COOH, where Y represents a C₁₋₅ alkylene group, provided that at least one R6 in the first chain is covalently connected to an R6b in the second chain via an amide bond formed between an amine group in said R6 and a carboxylic acid in said R6b;
each R7 is independently selected from the group consisting of a hydrogen atom, a methyl group, an ethyl group, a n-propyl group, an isopropyl group, a methoxyethyl group, a hydroxymethyl group, and a hydroxyethyl group;
R8 represents a carboxyl group or a hydrogen atom;
R9 represents a covalent bond, a linear or branched alkylene having from 1 to 10 carbon atoms, or a linear alkylene having from 1 to 5 carbon atoms having from 1 to 3 substituents selected from the group consisting of a methoxy group, a hydroxymethyl group, a hydroxyethyl group and a methoxyethyl group;
w, x, y, z are independently of each other, an integer of from 1 to 50.

3. The water-soluble crosslinked copolymer of claim 1, wherein the weight average molecular weight of the water-soluble crosslinked copolymer is from 2,000 to 1,000,000 Daltons, preferably 5,000 to 500,000 Daltons, more preferably from 10,000 to 250,000 Daltons.

4. The water-soluble crosslinked copolymer of claim 2, wherein said first chain is a random copolymer comprising constitutional unit (A′) and/or (A″), constitutional unit (B) and constitutional unit (C).

5. The water-soluble crosslinked copolymer of claim 2, wherein
the first chain comprises a constitutional unit (A′) where X is O, R1 is methylene and E is a covalent bond; or
the first chain comprises a constitutional unit (A″).

6. The water-soluble crosslinked copolymer of claim 2, wherein constitutional unit (B) represents a constitutional unit formed from the polymerisation of one of the group consisting of allylamine hydrochloride, 4-vinylaniline, 2-aminoethyl methacrylate hydrochloride, 2-aminoethyl acrylate, amino acrylate, N-(2-aminoethyl) methacrylamide hydrochloride, N-(3-aminopropyl)methacrylamide hydrochloride, and 2-aminoethyl methacrylate phenothiazine.

7. The water-soluble crosslinked copolymer of claim 2, wherein constitutional unit (B) has the formula 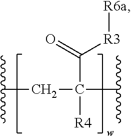
wherein
R3 represents O or NH, R4 is as defined in claims 2 and R6a represents —Y—CH₂—NH₂ or —Z—NH₂, where Y represents a C₁₋₅ alkylene group and Z represents a C₆₋₁₂ aryl group.

8. The water-soluble crosslinked copolymer of claim 2, wherein constitutional unit (C) has the formula 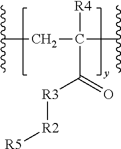
wherein
R2 represents a linear or branched alkylene group having from 1 to 18 carbon atoms, a polyoxyalkylene group with a unit number of from 1 to 20, or an arylene group having from 6 to 18 carbon atoms,
R3 represents O or NH;
R4 is as defined in claim 2;
R5 represents CₙH₂ₙ₋ₘ₊₁(OH)ₘ, where n represents an integer of from 1 to 5, and m is 1, 2 or 3.

9. The water-soluble crosslinked copolymer of claim 8, wherein m is 1.

10. The water-soluble crosslinked copolymer of claim 8, wherein R2 represents an ethylene glycol or a propylene glycol having from 1 to 20 repeating units.

11. The water-soluble crosslinked copolymer of claim 2, wherein constitutional unit (C) is a constitutional unit formed from the polymerisation of one of the group consisting of 2-hydroxyethyl methacrylate, 2-hydroxyethyl acrylate, hydroxypolyethoxy (10) Allyl Ether, N-(2-hydroxypropyl)methacrylamide, glycerol monomethacrylate, 3-phenoxy-2-hydroxypropyl methacrylate, hydroxypropyl methacrylate, 4-hydroxybutyl acrylate, 2-hydroxypropyl acrylate, N-hydroxyethyl acrylamide, poly(ethylene glycol) methacrylate, poly(propylene glycol) methacrylate, and N-[tris(hydroxymethyl)methyl]acrylamide.

12. The water-soluble crosslinked copolymer of claim 2, wherein the weight average molecular weight of the first chain is from 500 to 100,000 Daltons, preferably from 2,000 Daltons to 50,000 Daltons.

13. The water-soluble crosslinked copolymer of claim 2, wherein constitutional unit (D) is a constitutional unit formed from the polymerisation of one of the group consisting of poly(acrylic acid), polymethacrylic acid, polystyrene-block-poly(acrylic acid), polymaleic acid, poly(acrylic acid-co-maleic acid), poly(D,L-lactide-block-acrylic acid), poly(acrylamide-co-acrylic acid), poly(N-isopropylacrylamide-co-acrylic acid), and poly(ethylene-co-acrylic acid).

14. The water-soluble crosslinked copolymer of claim 13, wherein constitutional unit (D) is a constitutional unit formed from the polymerisation of one of the group consisting of acrylic acid, methacrylic acid and 2-carboxyethyl acrylate.

15. The water-soluble crosslinked copolymer of claim 2, wherein the weight average molecular weight of the second chain is from 2,000 to 700,000 Daltons.

16. The water-soluble crosslinked copolymer of claim 2, wherein from 5% to 75% of carboxylic acid groups in the second chain are crosslinked to amine groups in the first chain.

17. A method for the preparation of the water-soluble crosslinked copolymer of claim 1, comprising the steps:
(a) mixing a monomer corresponding to constitutional unit (1), a monomer corresponding to constitutional unit (2), and a monomer corresponding to constitutional unit (3) in a solvent;
(b1) polymerising the monomer mixture; and
(c1) conjugating the polymer obtained in step (b1) to a polycarboxylic acid to form the water-soluble crosslinked copolymer.

18. The method of claim 17, further comprising a step (d):
(d) conjugating the water-soluble crosslinked copolymer obtained in step (c1) to a substrate.

19-23. (canceled)

24. A substrate comprising the water-soluble crosslinked copolymer of claim 1.

25. The water-soluble crosslinked copolymer of claim 1, wherein said amine group in the first chain is a primary amine group.
